(19) United States
(12) Patent Application Publication
(10) Pub. No.: US 2010/0326031 A1
(43) Pub. Date: Dec. 30, 2010

(54) WEED LINE TRIMMER ATTACHMENT FOR LAWN MOWERS AND METHOD OF ATTACHING LINE TRIMMER TO LAWN MOWERS

(76) Inventor: Blaine Branden, Sabin, MN (US)

Correspondence Address: Ross Brandborg, 503 N. 7th St. #206, Fargo, ND, 58102, US

(21) Appl. No.: 12/877,472

(22) Filed: Sep. 8, 2010

(51) Int. Cl. A01D 34/416

(52) U.S. Cl. 56/12.7

(57) ABSTRACT

A device allowing a user to removably attach a weed line trimmer to a lawnmower deck, allowing a user to activate the weed trimmer or automatically engaging during the mowing of a yard to trim areas beside the mower while mowing the yard, eliminating duplicate effort and also to relieve the stress of carrying the weed trimmer.

### CROSS-REFERENCE TO RELATED APPLICATIONS

None

### STATEMENT REGARDING FEDERALLY SPONSORED RESEARCH

No federally sponsored research

### REFERENCE TO A “SEQUENCE LISTING” OR OTHER APPENDIX

None

### BACKGROUND OF THE INVENTION

1. Field of the Invention

The invention is a device allowing a user to magnetically attach a weed line trimmer to a lawnmower deck. The trimmer can be activated during mowing to trim areas next to the mower. The trimmer can be activated manually or can automatically engage when contacted by a surface such as a tree or a fence. The trimmer is fastened to the lawn mower by a magnetic contact attachment. This invention solves several problems that exist in the field of mowing and lawn trimming.

A conventional mower cannot cut grass and weeds immediately surrounding a fixed object. This is because the mower blades are surrounded by the mower deck. The mower deck is encumbered by other parts, usually a cowling and wheels. These other parts of the mower create a gap between the fixed object and the cutting area. In this gap, the grass is not cut. To cut this grass a separate weed or grass line trimmer is usually employed to go back and trim the grass near the fixed objects. This second step of trimming the areas near the fixed objects can be time consuming. The current invention allows the individual mowing the lawn to trim next to the fixed objects as he mows. This eliminates the second step of backtracking over mowed areas to trim around the fixed objects.

Rare earth magnets were developed in the 1970's and 1980's. However, recent advancements in the production of these magnets have made them more available and less costly. The power of these magnets makes it possible to attach a line trimmer to a mower using only magnetic means.

Other devices exist that combine a line trimmer with a mower. However, these devices are generally bulky and cumbersome. These devices can be difficult to attach to a mower. Once attached, they are not easily removed. The current invention solves these problems by mounting the line trimmer to the mower with magnet or easy releasable fasteners.

2. Description of Related Art

The following United States patents are identified and disclosed herein. Several devices are disclosed relating to lawnmowers incorporating weed trimming components in addition to the mowing apparatus. However, all of them tend to incorporate such weed trimming components as a permanent installation or an integrated component.

In U.S. Pat. No. 6,601,374 to Smith and U.S. Pat. No. 7,644,565 to Uihlein, a conventional gas powered line trimmer is removeably mounted to a push type mower with means for activating the line trimmer with a switch to trim along areas next to the mower.

In U.S. Pat. No. 4,781,014 to Conboy, Jr., appears to convert a regular rotary mower to a cord line trimmer, replacing the blade with a cord reel with some form of line release.

In U.S. Pat. No. 4,756,147 to Savell, a wheeled attachment for a weed trimmer is provided, converting a standard weed trimmer into a wheeled line trimmer allowing the trimmer to be rolled instead of carried.

Several rotary trimmers under a singular deck are provided in U.S. Pat. No. 4,378,668 to Gullett.

In U.S. Pat. No. 5,701,728 to Koka and U.S. Pat. No. 5,174,100 to Wassenberg, combination mower and trimmer devices are disclosed feeding trimming lines along the blade of a rotary mower, allowing the rotary mower to be used as a line trimmer, the line extending beyond the radius of the rotary cutting blade.

In U.S. Design Pat. No. D 304,728 to Piorkowski and U.S. Pat. No. D 359,291 to Tihonovich, permanent trimmer attachments are disclosed, with '728 to Piorkowski disclosing a front attachment which maybe adjustable and '291 to Tihonovich which is set on the left front of the mower deck, such attachment being originally integrated into the mower deck. A fully adjustable line trimmer mounted to a mower deck is disclosed with the line trimmer being height, angle and directionally adjustable deriving the power source from either the mower engine shaft or electrical power from the mower.

In U.S. Pat. No. 5,065,566 to Gates, a flexible line trimmer attachment for a tractor driven mower deck for trimming while mowing is disclosed, having a boom which is deflected up to a 180 degree angle, such boom having a spring attaching to the boom to return the boom to a resting position.

The current invention makes the addition of a weed line trimmer to a conventional riding or push mower very convenient. It allows the user to attach the weed line trimmer with the simple use of a magnet. The magnetic bracket holds the weed line trimmer in places on the side of the mower deck. The weed line trimmer is then easily activated either with a manual switch mounted on the lawnmower controls or with a trigger switch when the weed line trimmer approaches and object and the trigger switch touches the object.

### BRIEF SUMMARY OF THE INVENTION

The primary objective of the current invention is to provide a means to allow a weed line trimmer to be easily attached to and removed from the deck of a lawnmower. A second objective of the invention is to provide such attachment means on any side of the mower deck to accommodate the choice of the user. A third objective is to provide the control trigger of the weed line trimmer in a location near the lawn mowers controls to easily activate the weed line trimmer. A fourth objective is to provide an automatic trigger to engage the weed line trimmer when the lawn mower approaches an object while mowing without distracting the user from attention to safety.

### BRIEF DESCRIPTION OF THE DRAWINGS

The following drawings illustrate by way of example and not limitation.

FIG. 1 is a perspective view of a riding lawnmower with the invention attached to the deck of the mower and the line mower engine attached to the fender of the tractor.

FIG. 2 is a perspective view of a push-type lawnmower with the invention attached to the deck of the mower and the line mower engine attached to the top of the deck of the mower.

FIG. 3 is an expanded view of a push-type lawnmower with the invention attached to the deck of the mower and the line mower engine attached to the top of the deck of the mower.

FIG. 4 is a top view of a push type lawnmower deck with the line trimmer invention attached to the deck of the mower.

FIG. 5 is a perspective view of a push-type lawnmower with the invention attached to the deck of the mower and the line mower engine attached to the top of the deck of the mower and an adhesive insert stuck to the mower deck allowing the magnetic line trimmer bracket to attach to a non-magnetic compatible lawnmower deck.

FIG. 6 is an expanded view of a push-type lawnmower with the invention attached to the deck of the mower and the line mower engine attached to the top of the deck of the mower and an adhesive insert stuck to the mower deck allowing the magnetic line trimmer bracket to attach to a non-magnetic compatible lawnmower deck.

FIG. 7 is a top view of a push-type lawnmower with the invention attached to the deck of the mower and the line mower engine attached to the top of the deck of the mower and an adhesive insert stuck to the mower deck allowing the magnetic line trimmer bracket to attach to a non-magnetic compatible lawnmower deck.

FIG. 8 is a top view of a push type lawnmower deck with the line trimmer invention attached to the deck of the mower in use as it approaches an object.

FIG. 9 is a top view of a push type lawnmower deck with the line trimmer invention attached to the deck of the mower in use as the automatic switch makes contact with an object.

### DETAILED DESCRIPTION OF THE INVENTION

### Device Components

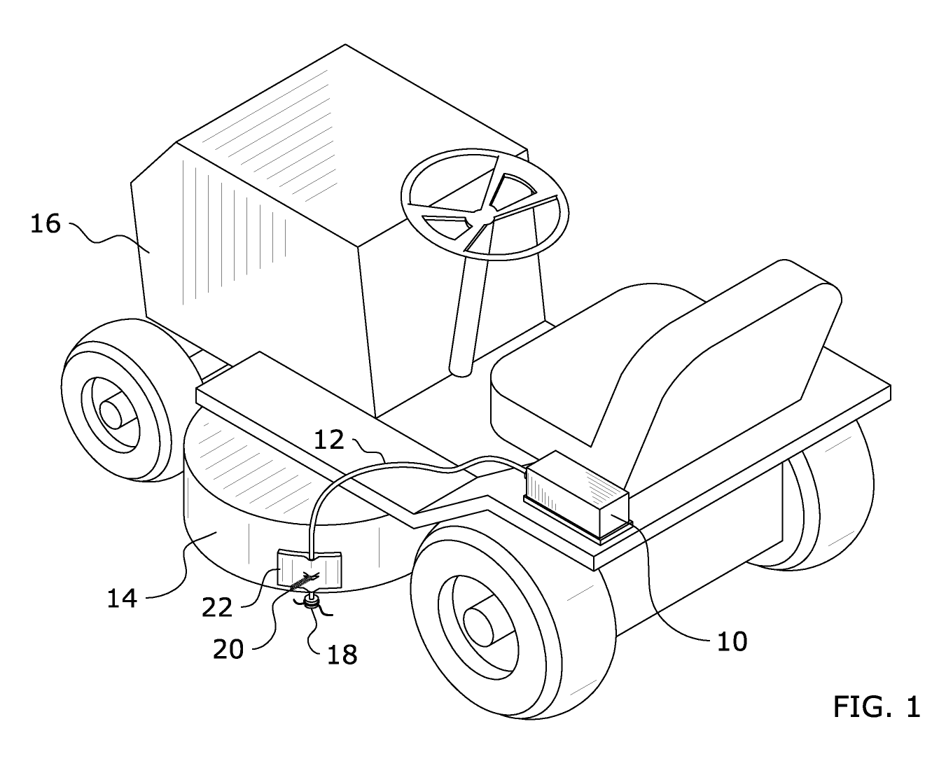

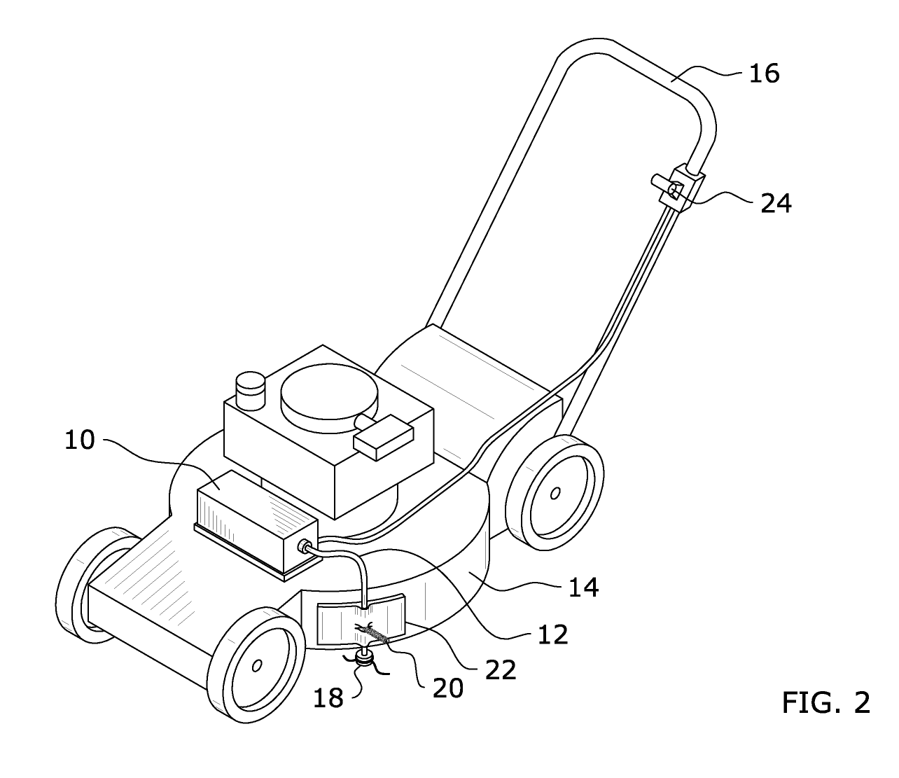

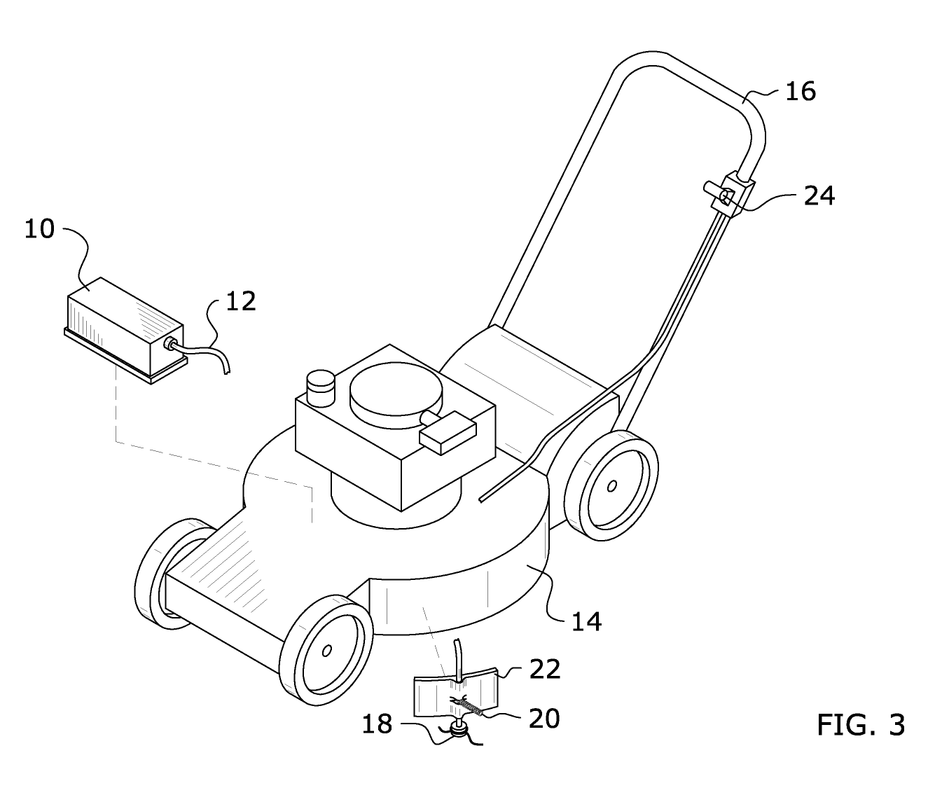

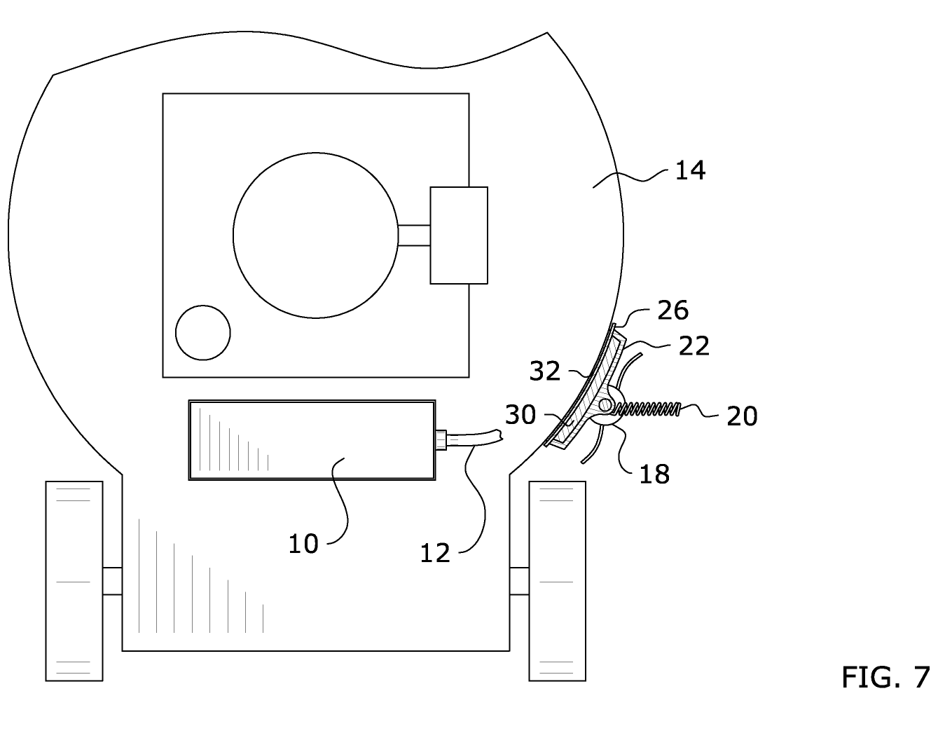

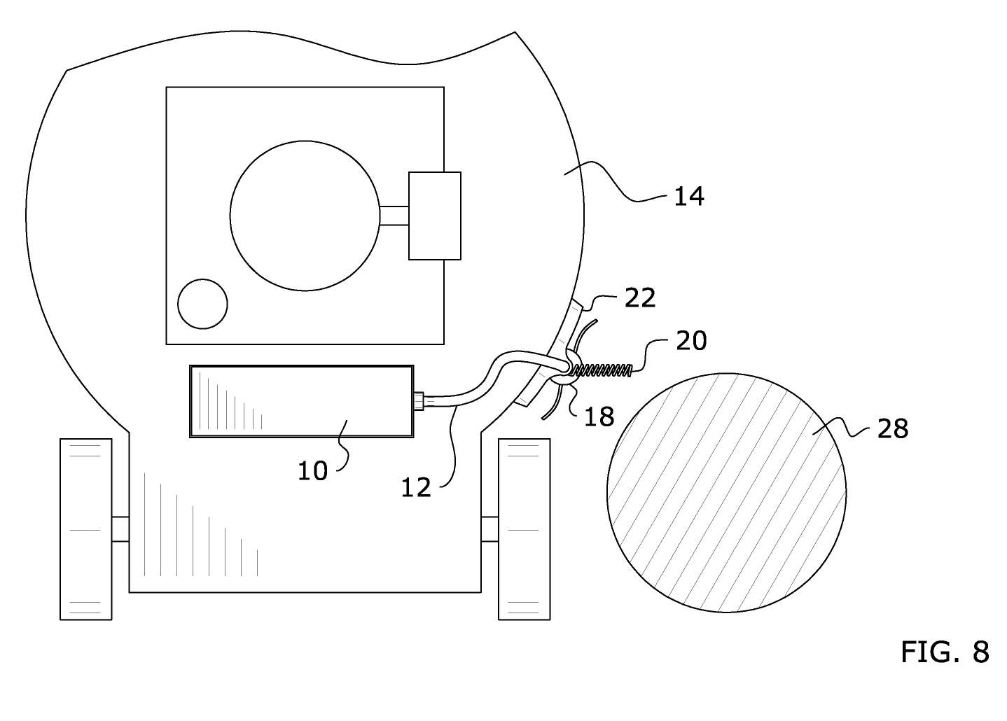

The invention, as shown in FIGS. 1-9 of the drawings, is a lawn trimming device which attaches to a lawnmower deck comprising of a power source (10), a weed or grass line trimmer head with flexible wire or synthetic lines (18), fastened to a bracket (22) which attaches to the side of a mower deck (14). The bracket/line trimmer assembly is connected to the power source that delivers rotational energy (10) through a ridged or flexible drive shaft (12). The line trimmer (18) is activated by either a manual trigger (24) or a pressure switch trigger (20) mounted on the weed line trimmer head (18). The lawnmower (16) to which the invention is attached can be any type mower, but for this embodiment a push-type mower or a riding lawn mower is described.

### Weed Line Trimmer Head

The weed line trimmer (18) is the type of trimming device in which a thin flexible plastic line or wire is rapidly rotated perpendicular to the blades of grass or the stems of weeds, thereby cutting the weeds or grass. The lines extend in the horizontal plane from the line trimmer head. The line trimmer head rotates rapidly in the horizontal plane. The line trimmer head rotates around a rod. The rod is fixed, it does not rotate.

### Bracket

The bracket (22) holds the weed line trimmer. The bracket attaches to (22) to the lawnmower deck (14). The bracket (22) must have an attachment component to accommodate the attaching the line trimmer (18). The connection of the weed line trimmer to the bracket (22) can be flexible to allow for give if the weed line trimmer contacts an object. The bracket must have a broad face that resembles the shape of the mower deck where it attaches to the mower deck. If the mower deck is flat, the face of the bracket must be flat. If the mower deck is curved, the face of the bracket must be curved. The face of the bracket is magnetized to accomplish attachment to the steel or alloy mower deck. The bracket (22) can be designed in several forms. The bracket (22) can me a ridged piece that fastens to the to the weed line trimmer head (18) in a perpendicular fashion and then fastens to the edge of the lawnmower deck (14). The bracket (22) can me a flexible piece that fastens to the weed line trimmer head (18) in a perpendicular fashion and then flexes to conform to the shape of the lawnmower deck, fastening to the edge of the lawnmower deck (14). The bracket (22) can be shaped to have two faces perpendicular to each other, forming a right angle. When bracket (22) fastens to the edge of the lawnmower deck (14) the second face of the bracket hooks over the top of the lawnmower deck (14). In this configuration the weed line trimmer (18) is still perpendicular to the one edge of the bracket (18) in a position to trim.

### Assembly

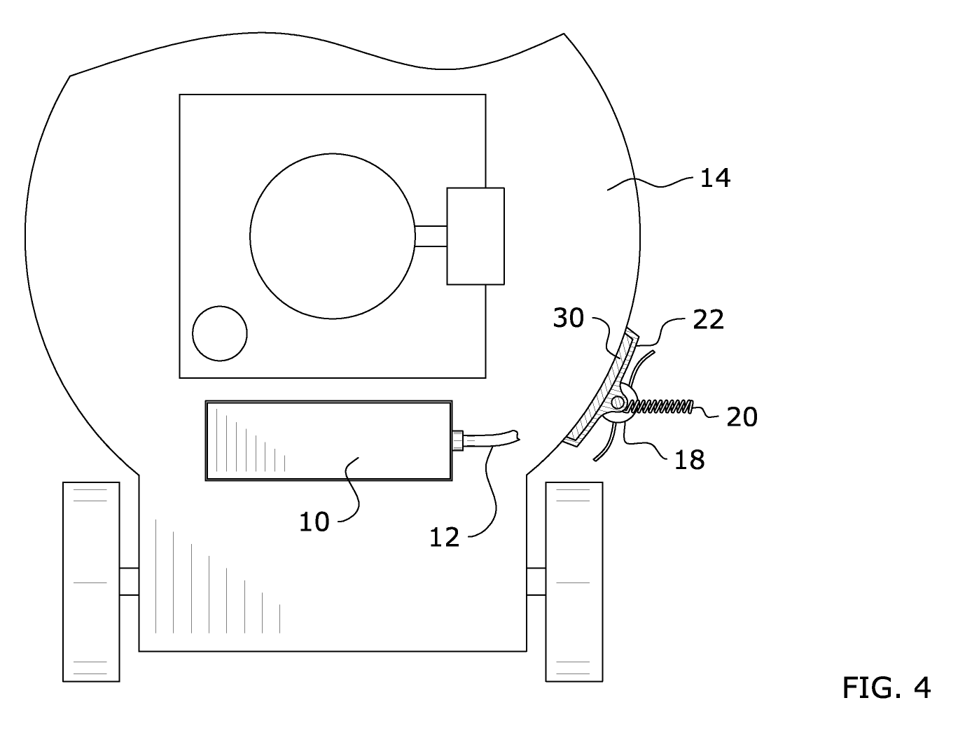

The mounting bracket (22), which attaches to the side of the deck of the lawnmower as shown in FIG. 4, can attach in any suitable means of fastening. What is contemplated is the bracket could be fastened to the lawnmower deck (14) by a magnet, bolts, snaps, or an easy release mechanism where the bracket hooks to the lawnmower deck (14). Perpendicularly fastened to the mounting bracket is the weed line trimmer (18). When the mounting bracket is fastened to the side of the lawnmower deck, the weed line trimmer will be in a position horizontal to the ground and ready to trim weeds or grass. The power source (10) for the weed line trimmer can be mounted anywhere as permitted on the lawnmower (16). The power source is the coupled to the line trimmer head to provide the rotation of the line trimmer head.

### Other Embodiments

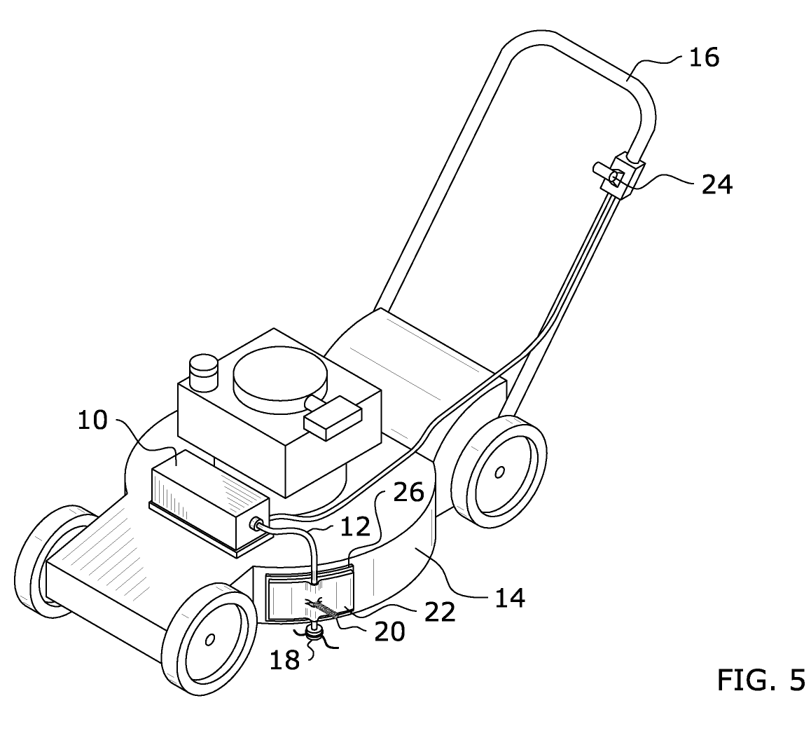

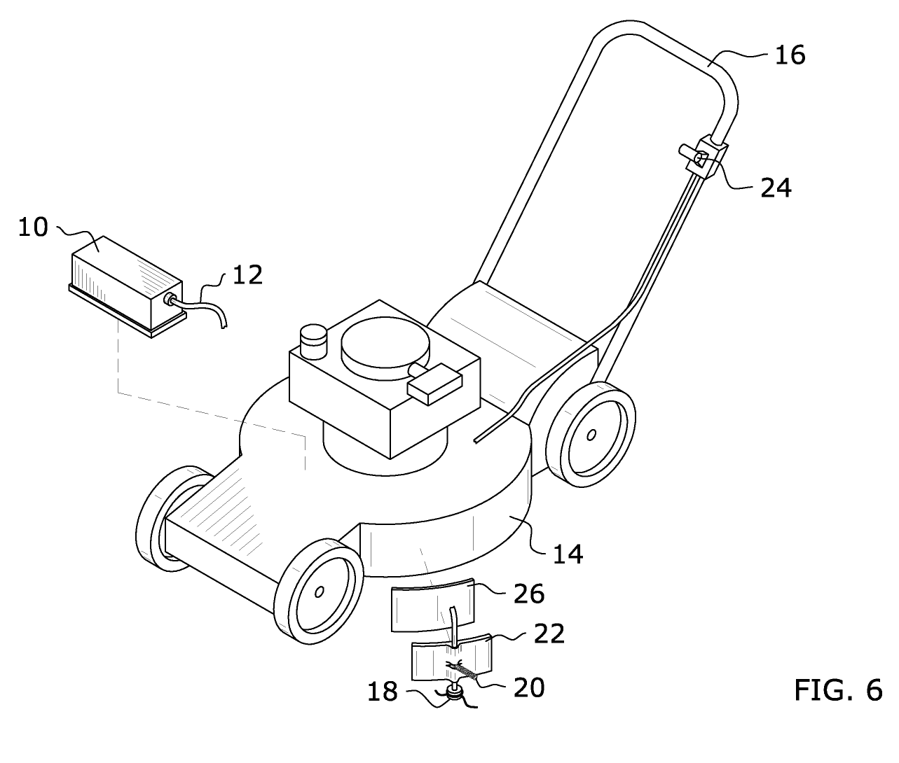

In another embodiment, if the deck (14) of the lawnmower is made of non-magnetic compatible material, then a metal piece (26) is adhesively attached to the deck (14) so the magnetic bracket (22) will affix to the mower deck as shown in FIGS. 5 and 6.

In another embodiment of the device the weed line trimmer head (18) has a low profile, meaning the line trimmer is not of the type where the line uncoils from the head, but rather the head or the line its self is manually replaced but provides for a smaller more compact device.

In another embodiment the weed line trimmer (18) is mounted on the mower deck (14) in such a way that the weed line trimmer rotates in the vertical direction, perpendicular to the ground.

Various methods of providing the rotation to the line trimmer head will be apparent to someone of ordinary skill in the art. The example of a power source mounted to the mower deck and coupled to the trimmer head is offered as an example and is not a limitation. In another embodiment the drive shaft (12) is not flexible but is ridged. In another embodiment the weed line trimmer (22) is driven by the lawnmowers primary motor. And in other configurations the motor is directly attached to the weed line trimmer (18) where the weed line trimmer/engine attachment is mounted on the mower deck. In other configurations the weed line trimmer (18) is not driven by a drive shaft at all, but rather is driven by hydraulic force.

In another embodiment, the weed line trimmer (18) is attached to the bracket (22) in a flexible manner, in such a way as to allow the weed line trimmer (18) to flex or bend in relation to the bracket (22) and/or mower deck (14) if it contacts an object.

It is anticipated that magnetically (30) attaching the weed line trimmer head (18) will allow for easy installation and removal, however in other embodiments the weed line trimmer head (18) bracket (22) combination could be attached to the lawn mower by any attaching means, permanent or otherwise.

### Operation

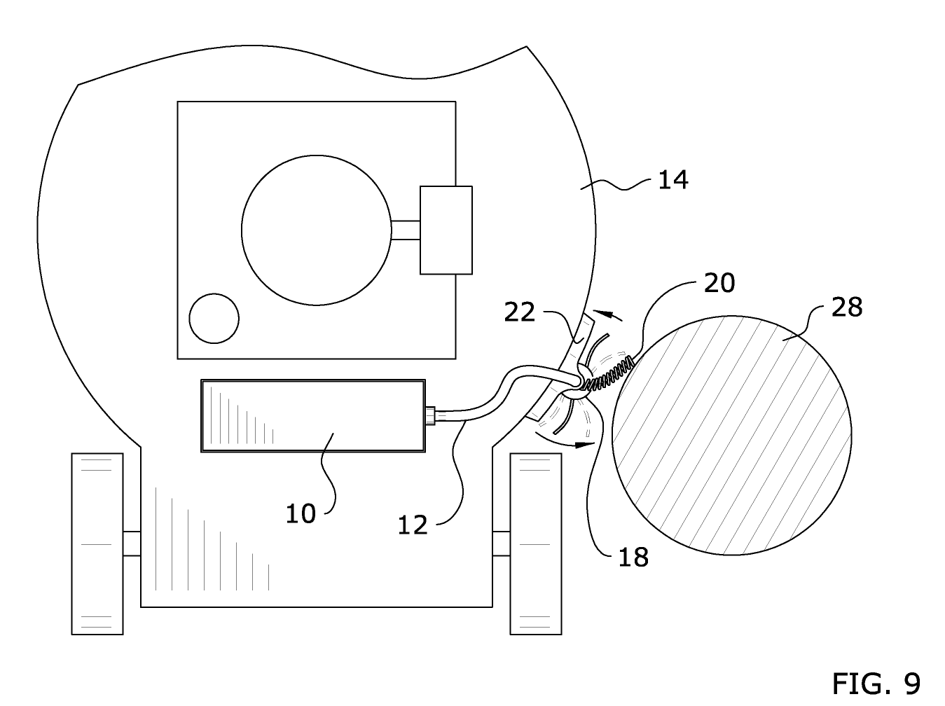

During operation the weed line trimmer (18) is activated either manually by activating the manual switch (24) or automatically when the trigger switch (20) on the weed line trimmer comes into contact with an object (28) as shown in FIG. 9. This allows mowing and trimming up against objects (28).

The engine (10) of the line trimmer can be either electric or internal combustion and is mounted to the lawnmower (14) in such a way as to allow the flexible drive shaft (12) to extend from the engine to the weed line trimmer head (18). It is anticipated that the engine can be mounted on the lawnmower in a position selected by the user. It is anticipated that the engine can be attached through magnetic mounting or any suitable mounting means including but not limited to permanently welded, or bolted to the lawnmower.

It is intended that this line trimmer mowing kit can be easily removed and reattached to different mowers (16).

Although exemplary embodiments of the present invention have been described hereinabove, it should be understood that the present invention is not limited to these embodiments, but may be modified by those skilled in the art without departing from the spirit and scope of the present invention, as defined in the appended claims.

What is claimed is:

1. A weed or grass line trimmer device for attaching to a lawnmower comprising:
a) a weed or grass line trimmer head;
b) a power source for providing rotational energy to the line trimmer head;
c) a bracket attached to the line trimmer head with the bracket containing a magnet to allow magnetic attachment of the bracket/weed line trimmer assembly to a lawnmower deck.

2. A weed or grass line trimmer device for attaching to a lawnmower comprising:
a) a bracket having attachable means to a lawnmower deck with a weed line trimmer attached to said bracket,
b) a power source for producing rotational energy,
c) a means for coupling rotational energy from said engine to said weed line trimmer.

3. The device of claim 2 wherein the bracket is flexible to conform to the profile of the lawnmower deck.

4. The device of claim 2 wherein said bracket attaches to the lawnmower deck by magnetic means.

5. The device of claim 2 wherein the lawnmower deck is non-magnetically compatible and a magnetically compatible material is adhesively attached to the mower deck to allow the magnetic bracket to attach to the mower deck.

6. A device of claim 2 wherein the bracket attaches to the lawnmower deck by an easy connect and release means.

7. The device of claim 3 wherein said power source is an electric motor.

8. The device of claim 2 wherein said power source is an internal combustion engine.

9. The device of claim 2 wherein said power source is derived from the primary lawnmower engine.

10. The device of claim 2 wherein said weed line trimmer head has a trigger switch which engages the line trimmer upon contact with an object.

11. The device of claim 2 wherein said weed line trimmer has a manual switch allowing the operator to engage the weed line trimmer manually.

12. The device of claim 2 wherein said weed line trimmer head has a low profile.

13. The device of claim 2 where the bracket has two sides forming a ninety degree angle.

14. The device of claim 2 where the weed line trimmer is flexibly attached to the bracket.

15. The device of claim 2 where the weed or grass line trimmer head is powered by hydraulic means.

16. A weed or grass line trimmer that is magnetically attached to a lawnmower deck.

17. A method for attaching a weed line trimmer to a lawnmower deck comprising the steps of:
a) attaching a weed line trimmer head to a bracket,
b) attaching a magnet to the bracket or,
c) magnetizing the bracket,
d) magnetically attaching the weed line trimmer bracket combination to a lawnmower deck.

18. The method of claim 13 further comprising;
a) coupling a rotational power source to the weed line trimmer head with a flexible drive shaft.
